(19) United States
(12) Patent Application Publication
(10) Pub. No.: US 2008/0162045 A1
(43) Pub. Date: Jul. 3, 2008

(54) Traffic flow and vehicle position detection system

(76) Inventor: Hung-Fu Lee, Banchiau City (TW)

Correspondence Address: Troxell Law Office Pllc, Suite 1404, 5205 Leesburg Pike, Falls Church, VA, 22041, US

(21) Appl. No.: 11/647,443

(22) Filed: Dec. 29, 2006

(51) Int. Cl. G01C 21/02

(52) U.S. Cl. 701/213

(57) ABSTRACT

The present invention provides a traffic flow and vehicle safety and position detection system, which includes a vehicle detection host within a vehicle, a remote server system and a mobile telephone number. When being used to monitor traffic flow, GPRS (General Packet Radio Service) is used to link up the vehicle detection host with the remote server system and transmit traveling vehicle information to a remote server, wherein the information is stored. When being used to prevent vehicle theft, a vehicle owner is able to phone the remote server system via the mobile telephone number, thereby enabling the remote server system to detect location of the vehicle detection host. Hence, the mobile telephone number enables the vehicle owner to have control over the status of his vehicle at all times.

### BACKGROUND OF THE INVENTION

(a) Field of the Invention

The present invention relates to a traffic flow and vehicle position detection system, and more particularly to a detection system which affiliates different telecommunications operators, especially to a detection system that is not only able to serve as a traffic flow detection system via a GPS (Global Positioning System) system, but is also able to achieve effectiveness as a vehicle anti-theft system by integration of telecommunications operators.

(b) Description of the Prior Art

A conventional method for monitoring traffic flow merely adopts a monitoring system whereby a detection system is set up by a road, and, according to traffic flow detected by the detection system, a monitor lens is used to transmit traffic status to a monitoring center through a specific communication media, whereupon information is then sent to the various types of media, including the Internet, radio stations or television to provide the driver with traffic status information, thereby enabling the driver to avoid roads or areas with traffic congestion. Such prior art monitoring systems have been in continual use for decades, but they are unable to effectively resolve the problem of traffic congestion.

Hence, the present invention was developed in order to resolve the aforementioned problems. The present invention combines a GIS (Geographic Information System) database with a GPS (Global Positioning System) system to achieve real-time detection of vehicle speed and traffic flow combined with a vehicle anti-theft and positioning method to achieve a detection system able to both detect traffic flow and prevent vehicle theft.

### SUMMARY OF THE INVENTION

Accordingly, the inventor of the present invention, having accumulated years of extensive experience in the research, design and manufacture of related products, painstakingly invested a great deal of effort to make improvements, and after repeated trials and testing, finally succeeded in developing a traffic flow and vehicle position detection system of the preset invention.

A primary objective of the present invention is to provide the traffic flow and vehicle position detection system with functionality to enable a traveling vehicle to quickly acquire traffic flow status, in addition to enabling the vehicle driver to detect vehicle location after leaving the vehicle, thereby achieving anti-theft effectiveness.

In order to achieve the aforementioned objective, the traffic flow and vehicle position detection system of the present invention primarily comprises a vehicle detection host, a remote server system and a matching mobile telephone number. The vehicle detection host is installed within a vehicle and connected to the vehicle system, thereby enabling receiving basic signals when the vehicle is traveling, and enabling the vehicle detection host to serve as one portion of the vehicle anti-theft system.

The remote server system in addition to having a GIS (Geographical Information System) system is also provided with a map information system database. Moreover, the remote server system is linked up with telecommunications operators, thereby enabling a user to phone the remote server system via the mobile telephone number, whereupon the remote server system transmits signals to make contact with the vehicle detection host, which in turn transmits geographical coordinates of the vehicle detection host to the remote server system. Geographical location matching is then carried out using the map information system database built in the remote server system, thereby enabling the user to quickly know current whereabouts of his vehicle, and further achieving anti-theft effectiveness.

The vehicle detection host is able to acquire real-time relative position and traveling speed of the vehicle at all times while the vehicle is in a traveling state via a GPRS (General Packet Radio Service) receiver, and transmit the acquired data to the remote server system, thereby enabling the remote server system to store the traveling vehicle data in a GIS database, and to enable the remote server system to transmit the traffic situation to the user in real time via telecommunications operators, and further enabling the user to quickly acquire real-time traffic information.

Furthermore, when a vehicle driver leaves his vehicle, he is able to phone the remote server system via the mobile telephone number, whereupon the remote server system establishes communication with the vehicle detection host and matches corresponding geographical location of the vehicle detection host, after which geographical location of the vehicle is reported back to the vehicle owner via the remote server system or the telecommunications operator or satellite telecommunications operator, thereby enabling the vehicle owner to quickly know the location of his vehicle, and validate whether his vehicle has been stolen or not.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view of the system according to the present invention.

FIG. 2 shows a schematic view of a vehicle detection host according to the present invention.

FIG. 3 shows a schematic view of a remote server system according to the present invention.

### DETAILED DESCRIPTION OF THE PREFERRED EMBODIMENTS

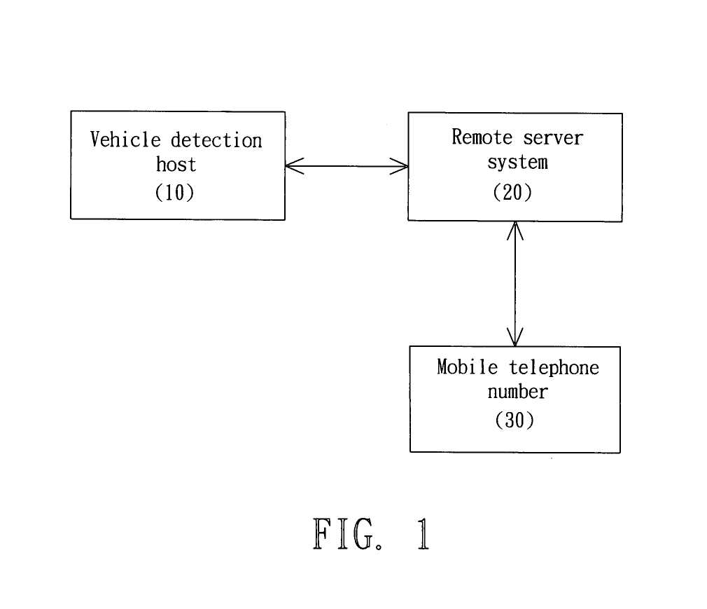

Referring to FIG. 1, which shows a schematic view of system composition of a traffic flow and vehicle position detection system of the present invention, wherein a position detection system comprises a vehicle detection host 10, a remote server system 20 and at least one mobile telephone number 30. The vehicle detection host 10 is installed within a vehicle, and the mobile telephone number 30 is set up in conjunction with the vehicle detection host 10 via the remote server system 20.

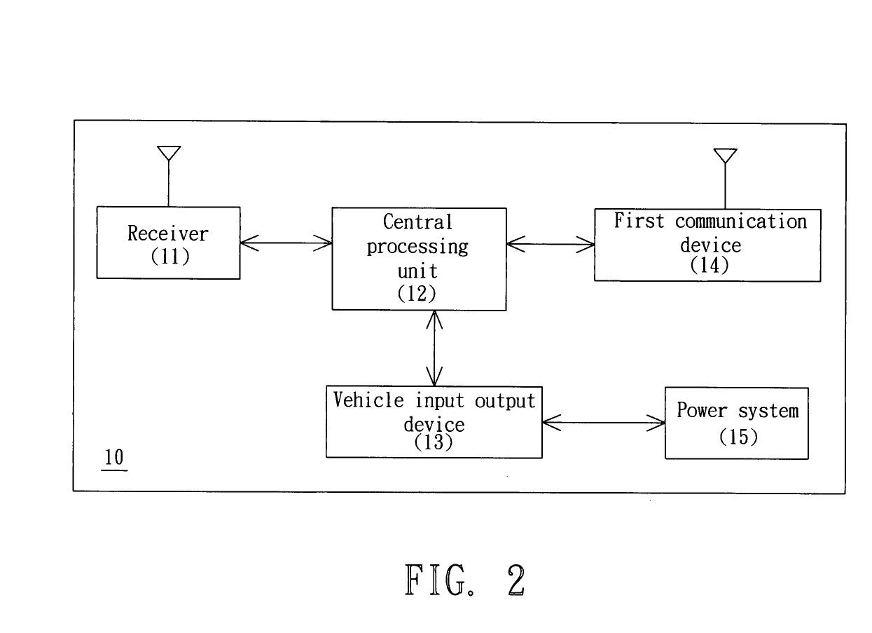

Referring to FIG. 2, which shows a schematic view of system composition of the vehicle detection host 10 of the present invention, wherein the vehicle detection host 10 comprises a GPS (Global Positioning System) receiver 11, a central processing unit 12, a vehicle input output device 13 and a first communication device 14.

The GPS receiver 11 is able to convert received satellite signals into international standard NMEA 0183 (National Marine Electronics Association) format, which are then sequentially transmitted to the central processing unit 12 and the vehicle input output device 13. The vehicle input output device 13 controls basic signals of the vehicle, enabling the vehicle detection host 10 to serve as one portion of the vehicle anti-theft system, and primarily integrated therein. The vehicle input output device 13 includes a display unit. Moreover, the vehicle input output device 13 is connected to a power supply system 15, which is used to convert a power supply within the vehicle into usable power.

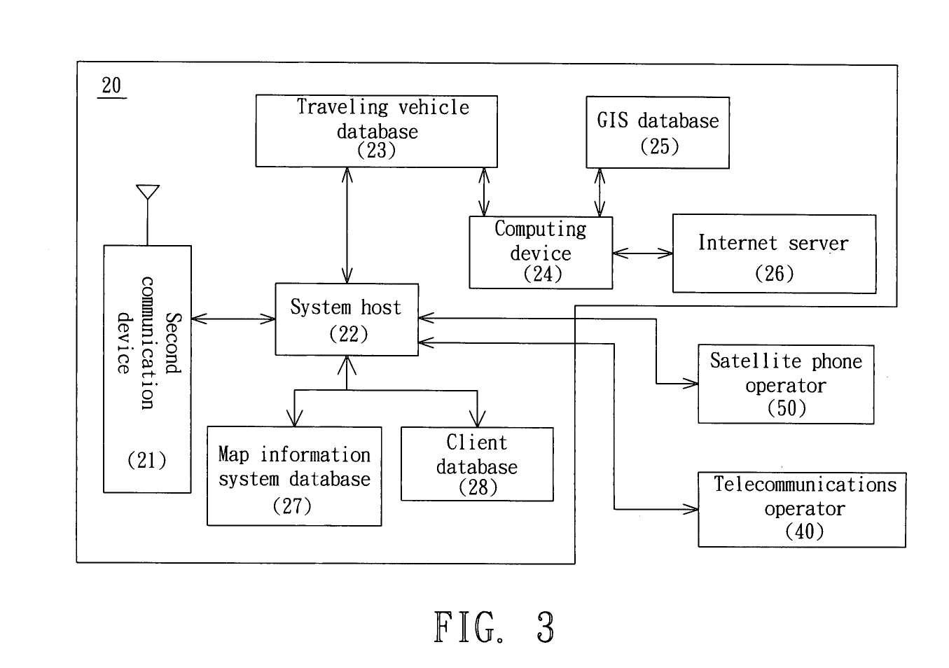

Referring to FIG. 3, which shows a schematic view of a remote server system of the present invention, wherein the remote server system 20 comprises a second communication device 21, a system host 22, a traveling vehicle database 23, a computing device 24, a GIS (Geographical Information System) database 25, an Internet server 26, a map information system database 27 and a client database 28.

The second communication device 21 is able to receive information transmitted by the first communication device 14 of the vehicle detection host 10, and the system host 22 enables the acquired information to be recorded in the traveling vehicle database 23. GPS data acquired by the second communication device 21 includes vehicle speed data and longitude and latitude data. The computing device 24 is used to process the information to produce specific average speed per hour data, GIS data, and integration thereof to form a point data traffic information format, which is correlated with the GIS database 25. Then the computing device 24 carries out repeated calculations to accumulate plural traffic information. Finally the Internet server 26 is used to transmit the traffic information to the Internet or the system host 22 is used to transmit the traffic information to a telecommunications operator 40 or a satellite telecommunications operator 50, thereby enabling the vehicle driver to use the vehicle input output device 13 in the vehicle detection host 10 to know real-time traffic status. Referring again to FIG. 1, the telecommunications operator 40 or the satellite telecommunications operator 50 can also transmit messages to the mobile telephone number 30 of the vehicle driver, thereby enabling the vehicle driver to obtain real-time traffic information via the mobile telephone number 30.

Referring to FIGS. 1, 2 and 3, when a vehicle driver leaves his vehicle, he is able to phone the remote server system 20 via the mobile telephone number 30, and after the remote server system 20 receives the phone call from the mobile telephone number 30, matching of client data is carried out in the client database 28 to locate the vehicle detection host 10 corresponding to the mobile telephone number 30, and implements message transfer with the vehicle detection host 10 via the second communication device 21 and the first communication device 14 to enable the vehicle detection host 10 to report back its location relative to the remote server system 20, which is then entered into the map information system database 27 to implement location matching. Finally, the matched geographical position is reported back to the vehicle driver via message service from the telecommunications operator 40 or the satellite telecommunications operator 50 or directly by speech from the remote server system 20, thereby enabling the vehicle driver to quickly know the location of his vehicle, and further achieving vehicle anti-theft effectiveness.

In particular, when a vehicle is stolen, the vehicle driver is able to promptly phone the remote server system 20 via the mobile telephone number 30, whereupon the remote server system 20 communicates with the vehicle detection host 10 to quickly obtain the current whereabouts of the vehicle, thereby assisting personnel handling locating the stolen vehicle to retrieve the stolen vehicle in the shortest time possible.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A traffic flow and vehicle position detection system, comprising:
a vehicle detection host that acquires geographical position and traveling vehicle status via a GPS (Global Positioning System) system; a remote server system that implements transmission of information with the vehicle detection host, and records geographical position of vehicle location and traveling vehicle status, moreover, transmits the geographical position of vehicle location and traveling vehicle status to the Internet, a telecommunications operator or satellite telecommunications operator; and
a mobile telephone number that establishes a contact relationship with the vehicle detection host via a setting of the remote server system.

2. The traffic flow and vehicle position detection system according to claim 1, wherein the vehicle detection host further comprises a GPS (Global Positioning System) receiver, a central processing unit, a vehicle input output device and a first communication device.

3. The traffic flow and vehicle position detection system according to claim 2, wherein the vehicle input output device further comprises a display unit and a power supply system, which enables converting a power supply within a vehicle into usable power.

4. The traffic flow and vehicle position detection system according to claim 2, wherein the GPS (Global Positioning System) receiver is able to convert received satellite signals into international standard NMEA 0183 (National Marine Electronics Association) format.

5. The traffic flow and vehicle position detection system according to claim 1, wherein the remote server system further comprises a second communication device, a system host, a traveling vehicle database, a computing device, a GIS (Geographical Information System) database, an Internet server, a map information system database and a client database.
